(19) United States
(12) Patent Application Publication
(10) Pub. No.: US 2014/0175111 A1
(43) Pub. Date: Jun. 26, 2014

(54) AUTOMATIC VENDING MACHINE

(71) Applicants: Hon Hai Precision Industry Co., Ltd., New Taipei (TW); Hong Fu Jin Precision Industry (WuHan) Co., Ltd., Wuhan (CN)

(72) Inventors: ZHI-YONG GAO, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/966,495

(22) Filed: Aug. 14, 2013

(30) Foreign Application Priority Data
Dec. 21, 2012 (CN) 2012105611835

(51) Int. Cl. G07F 11/38

(52) U.S. Cl. CPC G07F 11/38
USPC 221/133

(57) ABSTRACT

A vending machine which dispenses goods without risk of damage to the goods or the customer includes a cabinet, a receiving tray and a merchandise catch basket moveably received in the receiving tray. The cabinet includes a cabinet body and a door rotatably attached to the cabinet body. A number of merchandise shelves are located in the cabinet body and bought goods slide rather than drop into the catch basket. A first opening is defined in the door, and the receiving tray is attached to an inside of the door and the customer is prevented from interfering with or taking the bought goods until they are at rest in the merchandise catch basket which is moved out to be accessible to the customer.

### BACKGROUND

1. Technical Field

The present disclosure relates to electronic devices, more particularly to an automatic vending machine.

2. Description of Related Art

Vending machines allow customers to buy a lot of merchandise twenty four hours a day. When the customer retrieves the bought item from a merchandise catch opening of the vending machine, the customer can be hurt by energy of direct dropping motion. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an automatic vending machine in accordance with an embodiment.

FIG. 2 is an exploded, isometric view of the automatic vending machine of FIG. 1.

FIG. 3 is an assembled view of FIG. 2, and a merchandise catch basket of the automatic vending machine located in a first position.

FIG. 4 is similar to FIG. 3, and the merchandise catch basket of the automatic vending machine is located in a second position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

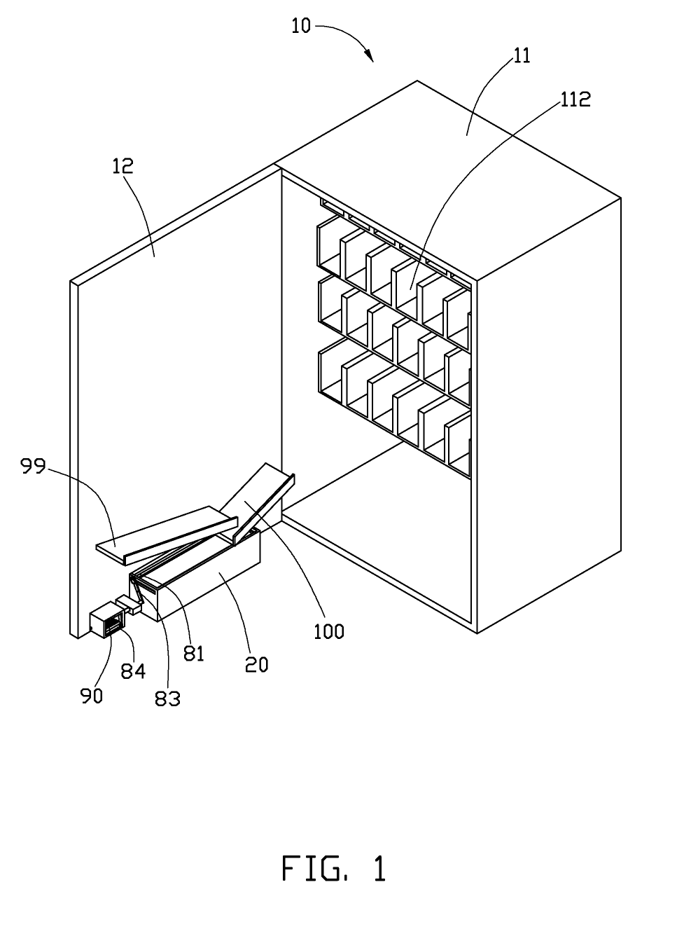

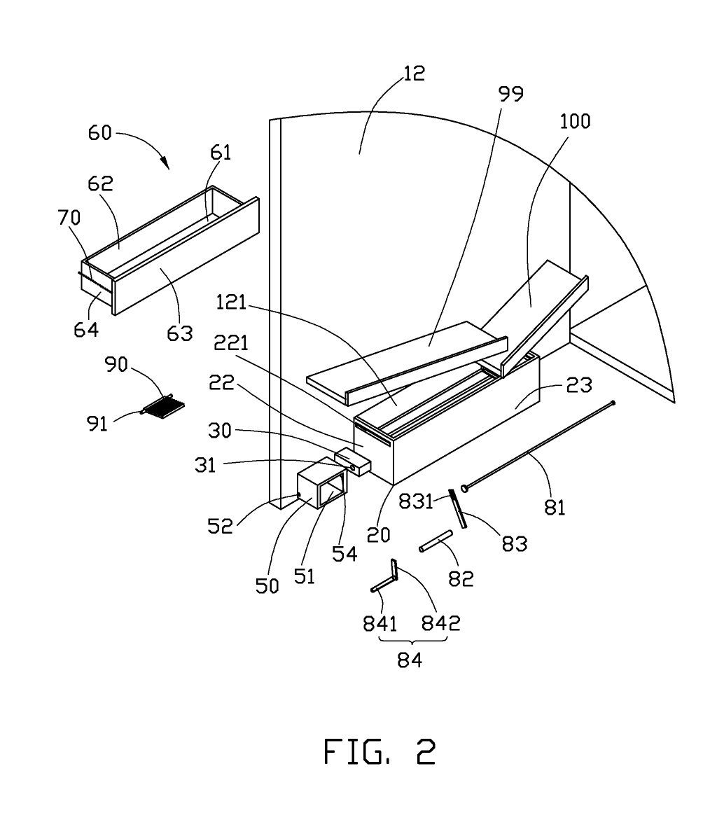

FIGS. 1 and 2 illustrate an automatic vending machine in accordance with an embodiment. The automatic vending machine comprises a cabinet 10 and a plurality of merchandise shelves 112 received in the cabinet 10. The cabinet 10 comprises a cabinet body 11 and a door 12 rotatably attached to the cabinet body 11.

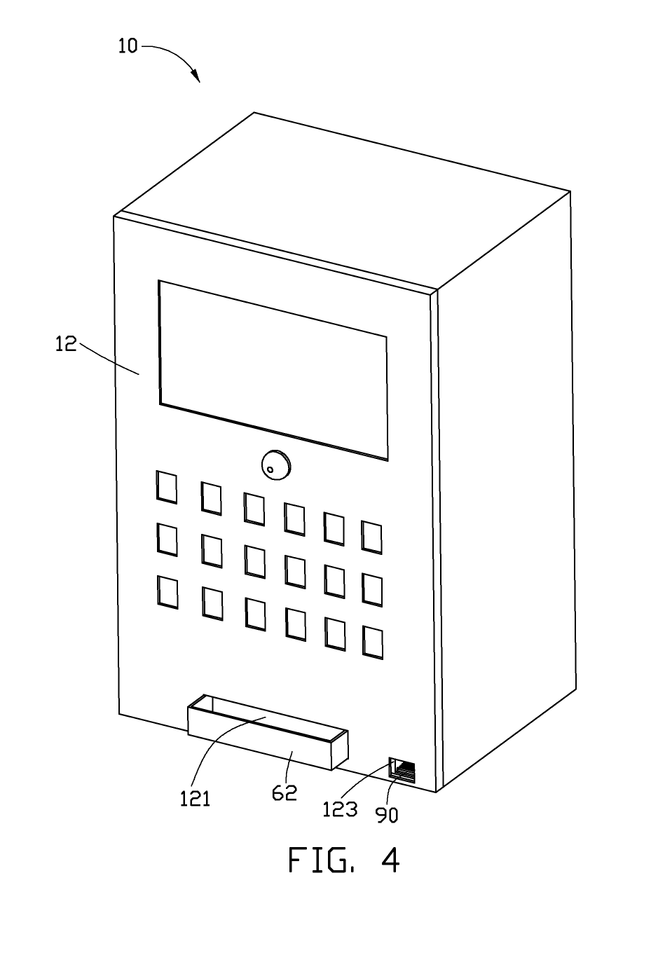

A first opening 121 and a second opening 123 (see FIG. 4) are defined in an outside of the door 12. A receiving tray 20, communicating with the first opening 121, is located on an inside of the door 12. The first opening 121 is substantially a rectangle. The receiving tray 20 comprises two side panels 22 and a rear panel 23 connected to the two side panels 22. The two side panels 22 extend from opposite edges of the first opening 121. In one embodiment, each side panel 22 is substantially perpendicular to the door 12 and the rear panel 23, and the rear panel 23 is substantially parallel to the door 12. A sliding slot 221 is defined in each side panel 22.

A first merchandise guiding member 99 and a second merchandise guiding member 100 extend from the door 12, and both are located and stacked above the receiving tray 20. In one embodiment, the first merchandise guiding member 99 extends rightly and downwardly so that towards the receiving tray 20, and the second merchandise guiding member 100 extends left and downwardly. one end of the first merchandise guiding panel 99 is located above one end of the second merchandise guiding member 100, so that merchandises drops on the first merchandise guiding member 99 can drop into the second merchandise guiding member 100. In one embodiment, bought items of merchandise drop on the first merchandise guiding member 99 and then drop into the second merchandise guiding member 100. In one embodiment, each of the first and second merchandise guiding members 99, 100 is substantially L-shaped.

A securing block 30 and an accommodating block 50 are attached to the inside of the door 12. The securing block 30 is located between the accommodating block 50 and the securing block 30, and a pivoting hole 31 is defined in the securing block 30. An accommodating space 51, communicating with the second opening 123, is defined in the accommodating block 50. A pair of accommodating holes 52 is defined in the accommodating block 50, and a punching hole 54, corresponding to the pivoting hole 31, is defined in the accommodating block 50.

A merchandise catch basket 60 is slidably received in the receiving tray 20. The merchandise catch basket 60 comprises a bottom plate 61, a front plate 62 extending from the bottom plate 61, a rear plate 63, and two side plates 64. In one embodiment, the front plate 62 is substantially perpendicular to the bottom plate 61, and the two side plates 64 are substantially parallel to each other and perpendicular to the front plate 62. A length of the front plate 62 is less than a length of the first opening 121, so the front plate 62 can extend through the first opening 121 and be accessible from the outside of the door 12. A length of the rear plate 63 is greater than the length of the first opening 121. Two resilient members 70 are secured to opposite sides of the rear plate 63.

A pushing post 81 is slidably received in the sliding slot 221 and is used to move the merchandise catch basket 60. A rotating shaft 82 is rotatably received in the pivoting hole 31. A connecting shaft 83 is connected to the pushing post 81 and the rotating shaft 82, and the connecting shaft 83 defines a receiving slot 831. A driven post 84 is connected to the rotating shaft 82 and comprises a pressing portion 841 and a connecting portion 842 connected to the pressing portion 841. In one embodiment, the connecting portion 842 is substantially perpendicular to the pressing portion 841. A foot treadle 90 is received in the accommodating space 51. Two poles 91 are located on opposite sides of the foot treadle 90.

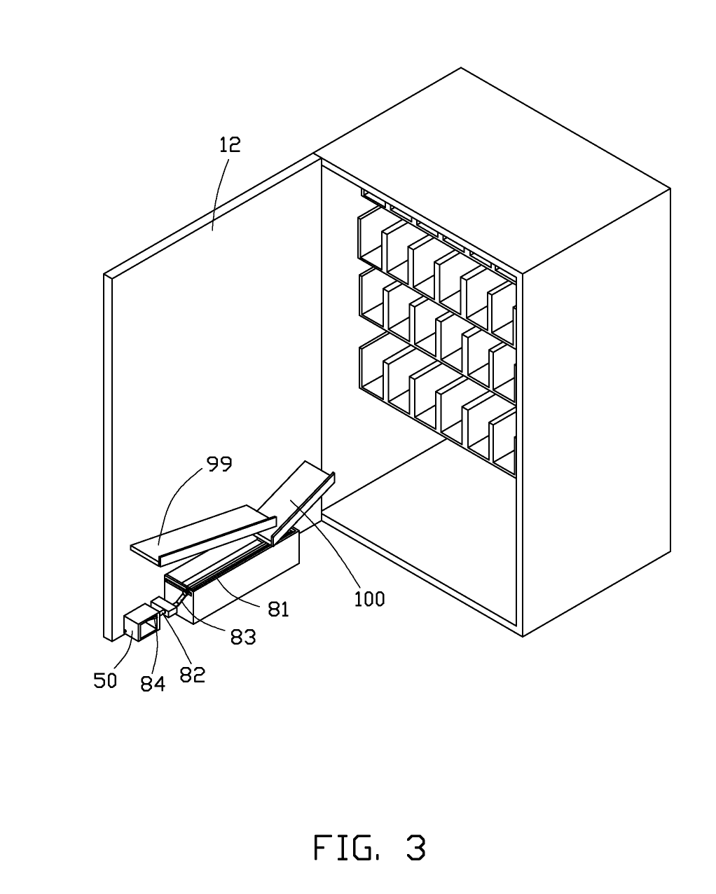

FIGS. 3-4 illustrate assembly of the automatic vending machine in accordance with an embodiment. In assembly, the merchandise catch basket 60 is received in the receiving tray 20, and the front plate 62 is towards the first opening 121 and located inside of the door 12. The free end of the resilient member 70 abuts the inside of the door 12. The pushing post 81 abuts the rear plate 63 and is slidably received in the two sliding slots 221, and one end of the pushing post 81 is received in the receiving slot 831. The rotating shaft 82 extends through the pivoting hole 31. A first end of the rotating shaft 82 is engaged with the connecting shaft 83 by means such as soldering. A second end of the rotating shaft 82 extends though the punching hole 54. The driven post 84 is received in the accommodating space 51, and the connecting portion 842 is engaged with the second end of the rotating shaft 82 by means such as soldering. The foot treadle 90 is received in the accommodating space 51. The two poles 91 are engaged in the two accommodating holes 52, to be rotatably engaged in the accommodating block 50. The backside of the foot treadle 90 constantly resists the pressing portion 841.

The merchandise catch basket 60 is moveable between a first position (see FIG. 3) and a second position (see FIG. 4). In the first position, the foot treadle 90 is located in an original state; the front plate 62 is located on the inside of the door 12; the resilient member 70 abuts the inside of the door 12; and the pushing post 81 abuts the rear panel 23 and is engaged in a first end of the sliding slot 221. In the second position, the foot treadle 90 is stepped on; the resilient member 70 is deformed; the pushing post 81 is disengaged from the rear panel 23 and engaged in a second opposite end of the sliding slot 221; and the front plate 62 extends through the first opening 121 and is then located on the outside of the door 12.

In use, the merchandise catch basket 60 is located in the first position. Bought items of merchandise drop into the first merchandise guiding member 99, from the merchandise shelves 112, and further drop into the merchandise catch basket 60, via the second merchandise guiding member 100. The foot of the customer extends through the second opening 123 and steps on the foot treadle 90, and the foot treadle 90 is rotated about the two poles 91 to urge the driven post 84 and the rotating shaft 82 to rotate together. When the rotating shaft 82 is rotated, the pushing post 81 is slid in the sliding slot 221 in a direction that is substantially perpendicular to the door 12, to push the merchandise catch basket 60 away from the rear panel 23, and the resilient member 70 is deformed. Until the pushing post 81 is engaged in the second end of the sliding slot 221, the front plate 62 extends through the first opening 121 to be located in the second position. Therefore, customer can catch the bought item of merchandise from the merchandise catch basket 60. After customer catches the merchandise from the merchandise catch basket 60, the foot treadle 90 is rotated back by the release of the resilient member 70 and the merchandise catch basket 60 is pushed back to the first position.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An automatic vending machine comprising:
a cabinet comprising a cabinet body and a door rotatably attached to the cabinet body;
a plurality of merchandise shelves, located in the cabinet body, configured to receive merchandise, and a first opening defined in the door;
a receiving tray attached to an inside of the door and configured to receive the merchandise from the plurality of merchandise shelves; and
a merchandise catch basket moveably received in the receiving tray;
wherein the merchandise catch basket is configured to extend through the first opening, to be located on an outside of the door.

2. The automatic vending machine of claim 1, wherein a second opening is defined in the door, a foot treadle is rotatably attached to the inside of the door and exposed out of the second opening, the foot treadle is connected to the merchandise catch basket, and the merchandise catch basket is movable by the foot treadle.

3. The automatic vending machine of claim 2, further comprising a driven post; wherein the driven post comprises a pressing portion and a connecting portion substantially perpendicular to the pressing portion; and the pressing portion is resisted on the foot treadle, and the connecting portion is connected to the merchandise catch basket.

4. The automatic vending machine of claim 3, further comprising a pushing post abutting the merchandise catch basket; wherein a sliding slot is defined in the receiving tray, and the pushing post is slidably received in the sliding slot.

5. The automatic vending machine of claim 4, further comprising a rotating shaft and a connecting post connected to the pushing post, a rotating shaft first end is engaged with the connecting portion, and a rotating shaft second end is engaged with the connecting post.

6. The automatic vending machine of claim 5, wherein a securing block is attached to the door, a pivoting hole is defined in the securing block, and the rotating shaft is rotatably engaged in the pivoting hole.

7. The automatic vending machine of claim 6, wherein an accommodating block is attached to the door, an accommodating space is defined in the accommodating block and communicates with the second opening, a pair of accommodating holes is defined in the accommodating block, and the foot treadle comprises two poles rotatably engaged in the pair of accommodating hole.

8. The automatic vending machine of claim 7, wherein a punching hole is defined in the accommodating block, and the first end of the rotating shaft extends through the punching hole and is engaged with the connecting portion.

9. The automatic vending machine of claim 8, further comprising a resilient member, wherein a resilient member first end is secured to the merchandise catch basket, and a resilient member first end is resisted on the door.

10. The automatic vending machine of claim 8, further comprising a first merchandise guiding member and a second merchandise guiding member, wherein the first merchandise guiding member is slanted relative to a bottom edge of the door and located above the second merchandise guiding member; and the second merchandise guiding member is slanted relative to the bottom edge of the door and located above the merchandise catch basket.

11. An automatic vending machine comprising:
a cabinet comprising a cabinet body and a door rotatably attached to the cabinet body; a plurality of merchandise shelves located in the cabinet body and configured to receive merchandise, and a first opening defined in the door;
a receiving tray attached to an inside of the door and configured to receive the merchandise from the plurality of merchandise shelves;
a merchandise catch basket moveably received in the receiving tray; and a resilient member located between the merchandise catch basket and the door; and
a pushing post slidably engaged with the receiving tray and abutting the merchandise catch basket;
wherein the merchandise catch basket is movable relative to the receiving tray between a first position and a second position; in the first position, the merchandise catch basket is received in the receiving tray and located on the inside of the door; in the second position, the resilient member is deformed, the merchandise catch basket extend through the first opening and located on an outside of the door.

12. The automatic vending machine of claim 11, wherein a second opening is defined in the door, a foot treadle is rotatably attached to the inside of the door and exposed out of the second opening, the foot treadle is connected to the merchandise catch basket, and the pushing post is slidable relative to the receiving tray by the foot treadle.

13. The automatic vending machine of claim 12, further comprising a driven post; wherein the driven post comprises a pressing portion and a connecting portion substantially perpendicular to the pressing portion; the pressing portion is resisted on the foot treadle, and the connecting portion is connected to the pushing post.

14. The automatic vending machine of claim 13, wherein a sliding slot is defined in the receiving tray, when the merchandise catch basket is located in the first position, the pushing post is engaged in a first end of the sliding slot; and when the merchandise catch basket is located in the second position, the pushing post is engaged in a second end of the sliding slot.

15. The automatic vending machine of claim 14, further comprising a rotating shaft and a connecting post connected to the pushing post, a rotating shaft first end is engaged with the connecting portion, and a rotating shaft second end is engaged with the connecting post.

16. The automatic vending machine of claim 15, wherein a securing block is attached to the door, a pivoting hole is defined in the securing block, and the rotating shaft is rotatably engaged in the pivoting hole.

17. The automatic vending machine of claim 16, wherein an accommodating block is attached to the door, an accommodating space is defined in the accommodating block and communicates with the second opening, a pair of accommodating hole is defined in the accommodating block, and the foot treadle comprises two poles rotatably engaged in the pair of accommodating hole.

18. The automatic vending machine of claim 17, wherein a punching hole is defined in the accommodating block, and the rotating shaft first end extends through the punching hole and is engaged with the connecting portion.

19. The automatic vending machine of claim 11, further comprising a first merchandise guiding member and a second merchandise guiding member, wherein the first merchandise guiding member is slanted relative to a bottom edge of the door and located above the second merchandise guiding member; and the second merchandise guiding member is slanted relative to the bottom edge of the door and located above the merchandise catch basket.
